(19) United States
(12) Patent Application Publication
(10) Pub. No.: US 2006/0249363 A1
(43) Pub. Date: Nov. 9, 2006

(54) Operating device

(75) Inventors: Axel Huegle, Furtwangen (DE); Juergen Paucker, Villingen-Schwenningen (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMINS AKTIENGESELLSCHAFT, Munich (DE)

(21) Appl. No.: 10/554,419

(22) PCT Filed: Apr. 19, 2004
(86) PCT No.: PCT/EP04/04151

§ 371 Date: Oct. 24, 2005

(30) Foreign Application Priority Data
May 12, 2003 (DE) 103 21 230.2

(51) Int. Cl. G07C 7/00

(52) U.S. Cl. 200/302.2

(57) ABSTRACT

The invention relates to a splashproof operating device (1), especially of a tachograph. A faulty seal often results in the entire apparatus breaking down because the fault remains undiscovered. The aim of the invention is to create an operating device (1) that ensures good functional safety and seals well towards the surroundings with the adjacent components. Said aim is achieved by an operating device in which contact areas (17) are elastically braced against each other. A decisive advantage of the inventive operating device consists of the fact that the abutting contact areas (17) of the operating element (9) are braced.

The invention relates to an operating device, in particular an operating device for unlocking a locking unit for locking a media unit of a printer in a housing of a tachograph for a motor vehicle, having an operating element, having a front element which has an operator-side front side and a rear side, and having a recess in the front element, in which the operating element can move.

Operating elements for controlling the functions of complexly operating apparatuses have been known since the existence of the apparatuses. As the interface between the user and the apparatus, high demands have been made of operating elements, with regard to tolerance of unfavorable motor activity of the user, with regard to robustness and, in particular, with regard to operating comfort. In the mechanical operating elements of the generic type, the force which is applied by the user during actuation can advantageously be utilized without additional auxiliary energy or force assistance to bring about the function which is to be controlled by means of the operating element. For this purpose, a mechanism is usually required which converts the constellation of force and travel for the actuation of the operating element, which constellation is as a rule unsuitable for the desired success, into functionally appropriate kinetics. A typical exemplary application for this is the unlocking button of the printer drawer of a tachograph for commercial vehicles. Great challenges are always set for the construction, if the advantages of a mechanical operating device with dirt resistance and spray water resistance in the region of the operating element are to be combined. For this purpose, use is made as a rule of a complex arrangement of seals or a folding bellows which compensates for the movement of the operating element and seals off the movement gap of the operating element. In addition to the serious cost disadvantages of the previous solutions, the mounting of the seals or folding bellows is also extremely complicated and susceptible to faults. In addition, the components which seal under elastic deformation are subject to rapid wear and, moreover, impair the function of the operating device on account of the damping of the movement of the operating element, which damping is undesirable as a rule and is caused by frictional forces. Moreover, worn components of previous solutions have the unfavorable property that the malfunction is not noticed immediately by the user, but can only be determined by means of a complex seal test. A defective seal thus often leads to the destruction of the entire unit, because the components which are to be protected come into contact with damaging dirt or moisture.

Proceeding from the problems and disadvantages of the prior art, the invention is based on the object of providing an operating device which affords satisfactory functional reliability with low costs and high operating comfort, and which is closed off in a sealing manner from the environment with the surrounding components.

According to the invention, the object is achieved by an operating device of the abovementioned type, in which the recess is surrounded by a first contact face on the front element, the operating element has a second contact face which faces the first contact face and is configured in such a way that it is in contact with the first contact face in a non-actuated position, and the second contact face of the operating element is stressed against the first contact face of the recess by means of an elastic element.

A decisive advantage of the operating device according to the invention lies in the prestressing of those contact faces of the operating element which lie against one another and that contact face which surrounds the recess on the front element by means of the elastic element, with the result that a permanently defined surface pressure can be set structurally between the two contact faces. As any wear on the contact faces is always of such an extent, even in the case of an unfavorable materials selection, which can be compensated for without problems by means of the elastic element without significant loss of the prestressing force, the sealing action of the arrangement is ensured permanently. Compared with the use, customary in the prior art, of radially sealing annular seals, the invention advantageously separates the prestressing function from the sealing function, with the result that the elastic deformation of the sealing element no longer also provides the pressing force of the seal. On account of the usually small-format construction of the seals, a permanently constant surface pressure on the seal cannot be ensured with a conventional arrangement. The arrangement according to the invention also advantageously makes it possible to dispense with an elastic seal, with the result that an almost completely wear-free sealing action brings about the desired sealing action using surfaces having a medium to high surface quality with a material which is not elastic to a very large extent. The invention expediently omits a sealing effect when the operating element of the operating device is actuated, as there is regularly the sealing requirement only when the operating element is not actuated in the preferred application for unlocking a locking unit of a media unit of a printer in a housing of a tachograph. Even if a seal is used, wear of the optionally elastic seal does not initially impair the sealing function between the contact faces which lie opposite one another, as a surface pressure is ensured which constantly remains equal. A further advantage of the arrangement according to the invention lies in the freedom of the movement of the operating element from frictional forces from a seal arrangement.

One advantageous development of the invention provides for the first contact face to be arranged on the rear side of the front element. In a corresponding configuration, the circumference of the operating element is surrounded by a second contact face which corresponds with the first contact face, said contact face firstly fulfilling the sealing function and secondly acting as a hold-back or hold-down or stop for the operating element.

The shape of the operating element is advantageously adapted to the shape of the recess in such a way that the operating element can be moved in a manner which is guided in the recess in the front element. The concrete configuration of the operating element as a pushbutton is appropriate if the operating element is secured against rotation in the recess by means of a first contour of the recess and a second contour of the operating element which is assigned to said first contour. Even in an operating element which is configured as a slide, the degree of freedom of movement can be reduced expediently with the recess in the front panel, for example to a single translatory degree of freedom in the plane of the front panel. For this purpose, the first and second contact faces can be configured appropriately as sliding bearings for the operating element which is configured as a slide.

It is similarly expedient to configure the operating element with a first guide which extends on the rear side and interacts with a corresponding second guide. As a result, the guiding function can be taken away from the front panel and the latter can be of particularly flat configuration. In addition, this guide can have a contour in the circumferential direction, with the result that the operating element cannot be rotated.

The first contact face and the second contact face can advantageously be in each case of conical configuration, with the result that although the two contact faces are removed from one another when the operating device is actuated, a certain radial guidance continues to be ensured. The operating element of the operating device can be designed to be particularly spacesaving if the first contact face and the second contact face are in each case of planar configuration. In the planar configuration, it has been determined by tests that, in the case of a round operating element of 14 mm which is configured as a pushbutton, a spring force of the elastic element which is preferably configured as a helical spring of 5 N is sufficient to achieve the desired sealing action; substantially proportional scaling in size terms would require an increase in the spring force according to the extent of the circumferential increase of the operating element in the event of identical sealing action requirements.

The advantages according to the invention come to bear, in particular, in the configuration of the operating element as a pushbutton, because the elastic element can be arranged and configured in such a way that, when the operating element is actuated, it exerts a restoring force on the operating element counter to the actuation direction. In this way, in the event of non-actuation, the operating element always comes into contact with the first and second bearing faces and is arranged there in a fixedly stressed and sealing manner.

In a further refinement of the invention, it has been shown that the operating element expediently has at least one hold-down which interacts with a hold-down element which is arranged on the rear side of the front element with a form-fitting connection in such a way that, in the absence of the front element, the restoring force from the elastic element on the operating element is absorbed by the hold-down element by means of the hold-down. The additional value of this arrangement lies in the decoupling from one another of the assembly steps of joining the operating element and attaching the front element. In interaction with the hold-down, the hold-down element secures the operating element in the prestressed position. The hold-down element can be a separate component, preferably in the form of a flat plate which is provided with a cut-out for the operating element, but can optionally also be a constituent part of a carrier, to which the front element is fastened.

In the following text, a specific exemplary embodiment is described in greater detail in order to clarify the invention, with reference to drawings, in which:

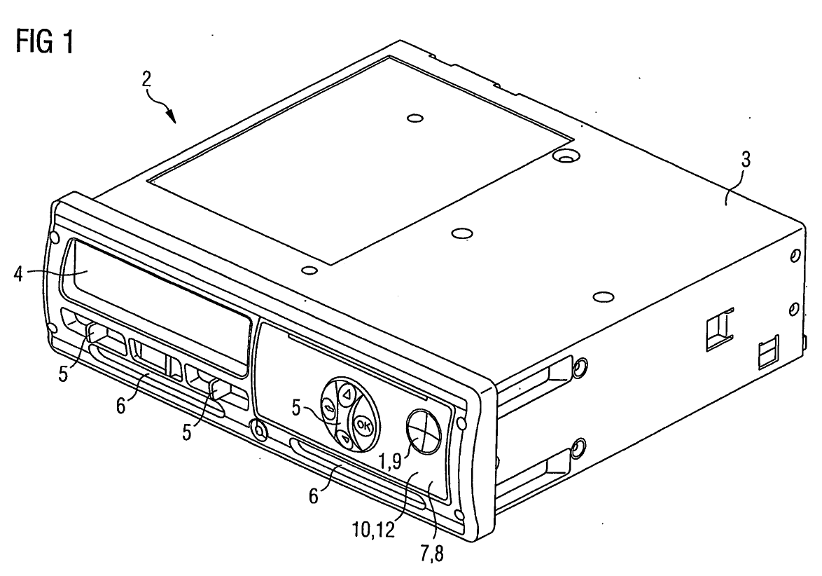

FIG. 1: shows a perspective illustration of a tachograph,

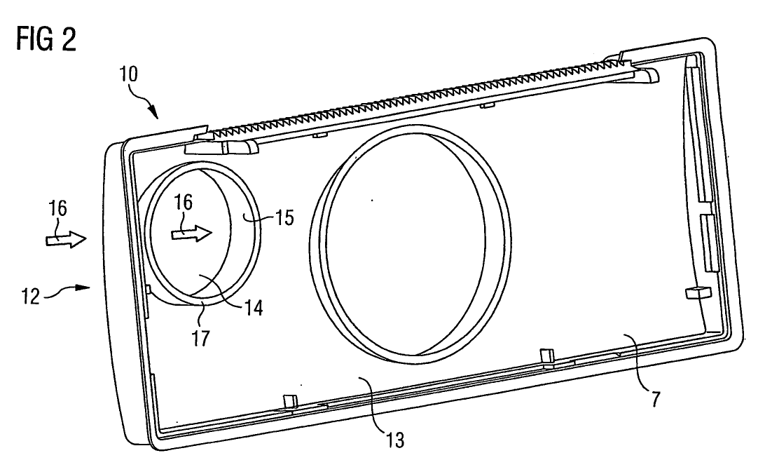

FIG. 2: shows a perspective illustration of a front element, from a rear-side perspective,

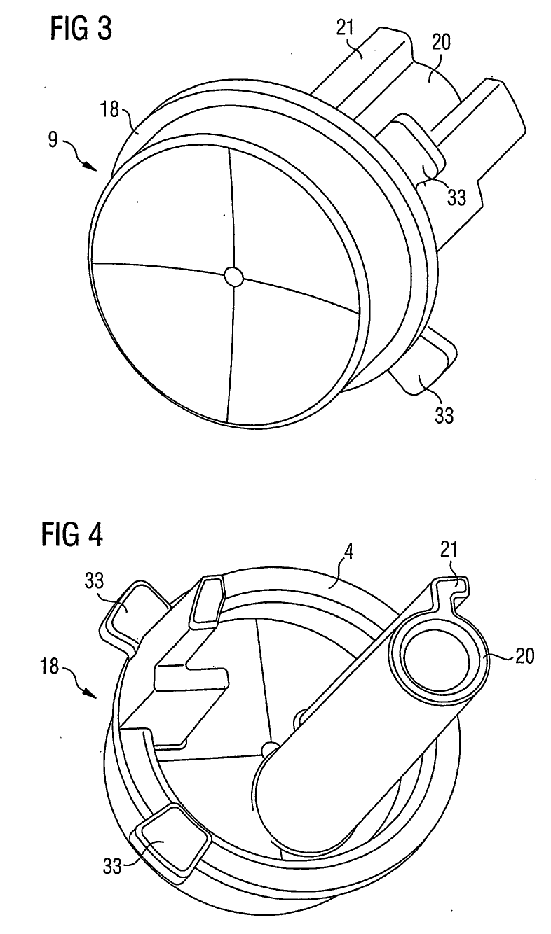

FIG. 3: shows a perspective illustration of an operating element, from a front-side perspective,

FIG. 4: shows a perspective illustration of an operating element, from a rear-side perspective,

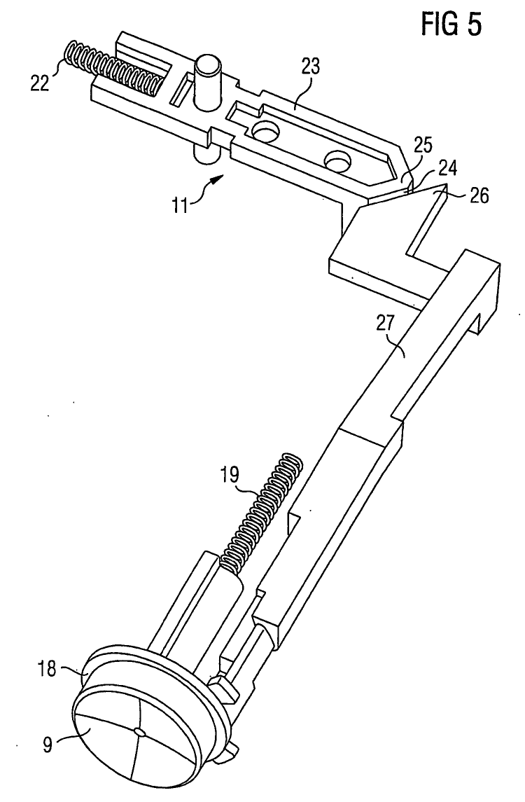

FIG. 5: shows a perspective illustration of an operating element, with an adjacent gear-mechanism arrangement,

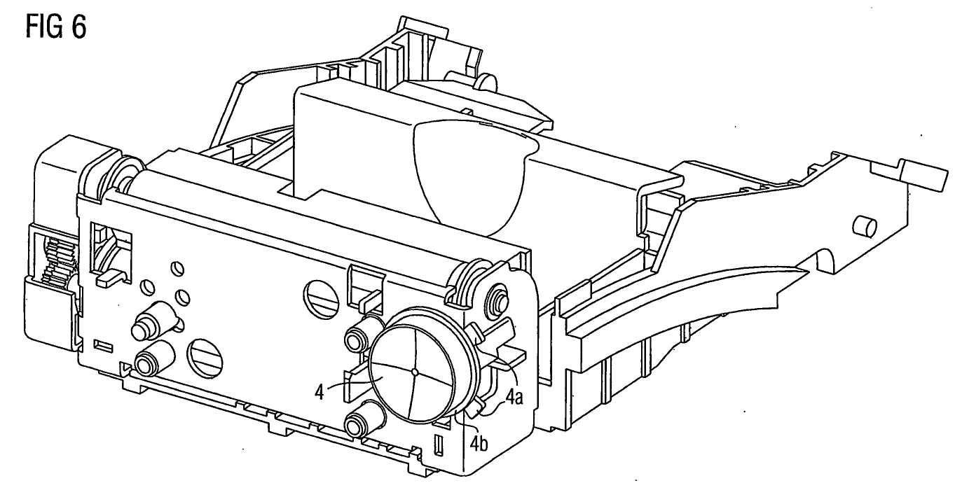

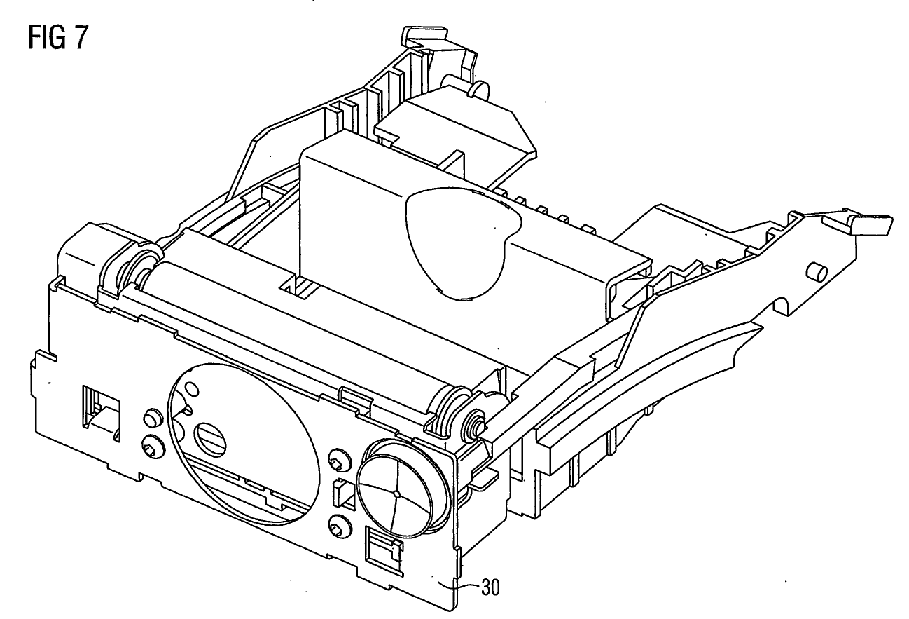

FIGS. 6, 7: show a perspective illustration of essential components of a printer having an operating device according to the invention, from a front view,

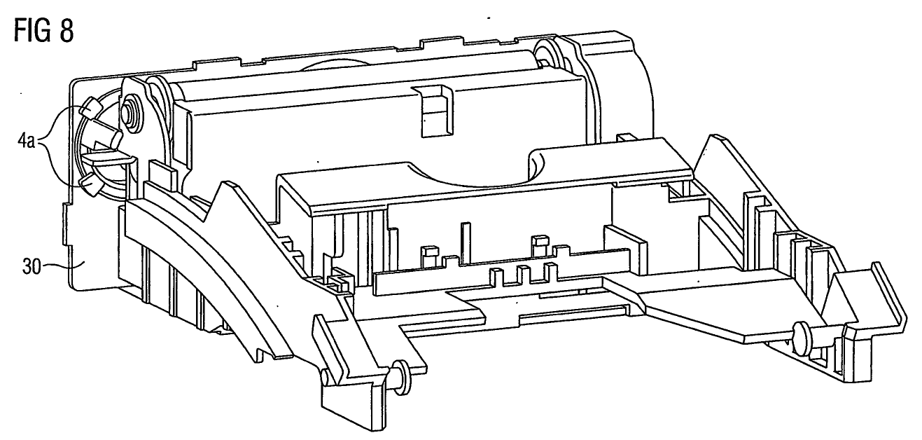

FIG. 8: shows the arrangement from FIG. 7 from a rear view, and

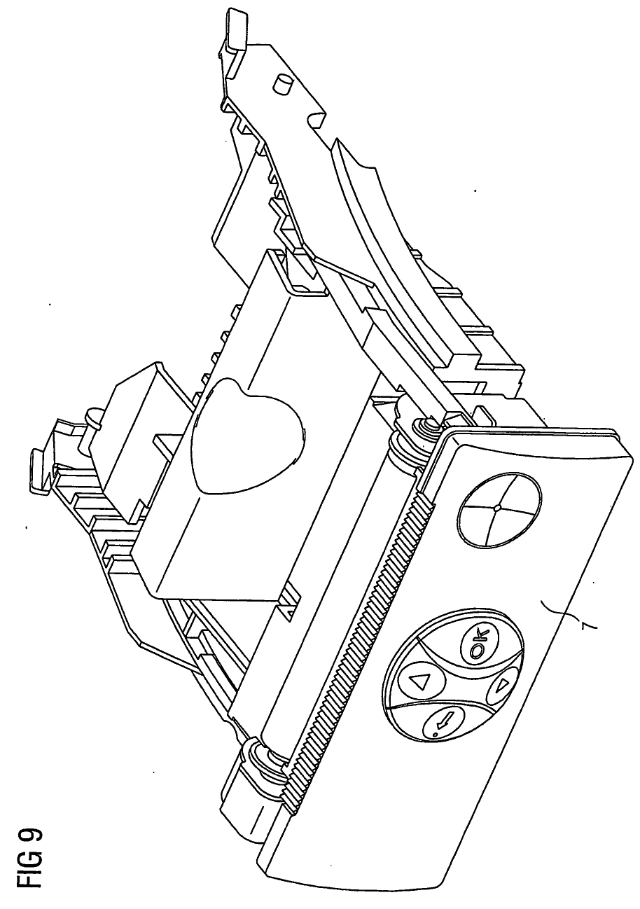

FIG. 9: shows a perspective illustration of a printer having an operating device according to the invention, with a mounted front panel.

The illustration of FIG. 1 shows a tachograph 2, having a housing 3, a display 4, various function keys 5, two chip card holding shafts 6, a media unit 7 of a printer 8 having an operating device 1 according to the invention, the operating element 9 of which is arranged jointly with function keys 5 on a front element 10. The operating device 1 is used for unlocking a locking unit 11 which holds the media unit 7 in the housing 3 and is shown in section in FIGS. 5 to 8.

The front element 10 which is shown as an individual part in FIG. 2 has a front side 12 which faces the user and a rear side 13 which faces away from the user. A recess 14 in the front element 10 of three-dimensionally flat design serves to arrange and guide the operating element 9. The recess 14 has a first cylindrical guide 15 which adjoins the recess and in which the operating element is guided movably with radial play in the actuation direction 16. A first contact face 17 is configured to be flat and annular, in accordance with the cylindrical shape of the recess 14, on the rear side 13 of the front element.

In the finally assembled state, the first contact face 17 of the front element 10 serves as a stop in a non-actuated position for the operating element 9, by an annularly configured flat second contact face 18 of the operating element 9 which is shown as an individual part in FIG. 3 being in contact with the first contact face 17 of the front element 10. At the same time, the first contact face 17 and the second contact face 18 interact as a seal against spray water and dirt, under elastic prestressing by means of an elastic element 19 which is shown in FIG. 5.

The rear-side illustration of the operating element 9 from FIG. 4 shows a guide element 20 which extends in the actuation direction 16 and has a first contour 21 in the circumferential direction with respect to the actuation direction 16, which first contour 21 interacts with a second contour (not shown) of a corresponding recess (not shown) in the printer 8 in such a way that the operating element 9 cannot be rotated. At the same time, the guide element 20 acts as an additional axial guide in the actuation direction 16, which additional axial guide prevents tilting of the operating element 9 and restricts the degree of freedom to the simple one, the translatory movement in the actuation direction 16.

The gear-mechanism arrangement (shown in FIG. 5 and adjoining the operating element 9) of the locking unit 11 which is actuated by the operating device 1 according to the invention substantially has a bolt 23 which is stressed counter to the unlocking device by means of a second elastic element 22, a sliding face guide 24 with oblique sliding faces 25, 26, and a slide 27. During actuation, the operating element 9 transmits the operating force as a translatory movement to the slide 27 which transmits this movement to the bolt 23 counter to the restoring force of the second elastic element 22 by means of the sliding face guides 24, 25. For unlocking, the user of the operating element 9 has to actuate it counter to the restoring forces of the first elastic element 19 and the second elastic element 22. As the high surface pressure forces between the first contact face 17 and the second contact face 18 which ensure the sealing action of the arrangement cannot be transmitted to the operating element 9 via the slide 27 on account of the risk of bending, the first elastic element 19 is provided in addition to the second elastic element 22. In the context of the relatively small movement amplitude of the operating element 9, the first elastic element 19 has a substantially constant restoring force of approximately 5 N, which the user has to apply for unlocking, in addition to the force from the second elastic element 22.

During assembly, the operating element 9 is initially attached to the printer 8, as shown in FIG. 6, and subsequently a hold-down element 30 with a second cut-out 31 for the operating element 9 is positioned over the operating element 9 which can move with play in the second cut-out 31. The hold-down element 30 interacts with two hold-downs 33 which protrude on the operating element 9 in the manner of wings radially with respect to the actuation direction 16, with the result that the operating element 9 is attached captively to a carrier 34 of the printer 8. These facts are also clearly apparent from the illustration of FIG. 8.

FIG. 9 shows the printer 8 with the operating device 1 according to the invention and the front element 10 which is fastened to the carrier 34. During the assembly, the front element 10 presses the operating element 9 in the actuation direction 16 by means of the first contact face 17 which is in contact with the second contact face 18, with the result that there is always play of approximately 0.75 mm between the hold-downs 33 of the operating element 9 and the hold-down element 30 in the actuation direction 16.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. An operating device, comprising:
an operating element,
a front element comprising an operator-side front side and rear side,
a recess in the front element, in which the operating element can move and which is surrounded by a first contact face on the front element,
the operating element comprising a second contact face which faces the first contact face and is configured such that it is in contact with the first contact face in a non-actuated position, and
the second contact face arranged to be removed from the first contact face upon actuation,
wherein the first contact face on the rear side of the front element is of annular and flat configuration,
wherein the operating element is surrounded circumferentially by the flat second contact face which corresponds to the first contact face and is of annular configuration,
wherein the first contact face and the second contact face have a medium to high surface quality, and
wherein the second contact face of the operating element is stressed against the first contact face of the recess by means of a first elastic element such that a permanently defined surface pressure is set between the first contact face and the second contact face, and the first contact face and the second contact face are arranged to interact as a seal against spray water and dirt.

17. The operating device according to claim 16, wherein the operating element is arranged to be movable such that it is guided in the recess in the front element.

18. The operating device according to claim 16, wherein the operating element comprises a first guide arranged to extend on the rear side in the actuation direction and interacts with a corresponding second guide.

19. The operating device according to claim 18, wherein the first guide and the second guide include a contour in the circumferential direction arranged such that the operating element cannot be rotated.

20. The operating device according to claim 16, wherein the first contact face and the second contact face comprise a conical configuration.

21. The operating device according to claim 16, wherein the operating element is a pushbutton and the first elastic element is arranged and configured such that when the operating element is actuated, the first elastic element exerts a restoring force on the operating element counter to the actuation direction.

22. The operating device according to claim 21, wherein the operating element is arranged to be secured against rotation.

23. The operating device according to claim 21, wherein the operating element is secured against rotation in the recess by means of a second contour of the recess and a first contour of the operating element which is assigned to said second contour.

24. The operating device according to claim 16, further comprising a carrier arranged on the rear side of the front element, and the front element is fastened to said carrier.

25. The operating device according to claim 24, wherein the operating element further comprises a hold-down which interacts with the carrier with a form-fitting connection such that, in the absence of the front element, the restoring force from the first elastic element on the operating element is absorbed by the carrier by means of the hold-down.

26. The operating device according to claim 16, further comprising:
a hold-down element arranged on the rear side of the front element, and
wherein the operating element has a hold-down which interacts with the hold-down element with a form-fitting connection such that, in the absence of the front element, the restoring force from the elastic element on the operating element is absorbed by the hold-down element by means of the hold-down.

27. The operating device according to claim 24, wherein the hold-down element is fastened to the carrier.

28. The operating device according to claim 26, wherein the hold-down element is fastened to the carrier.
